(19) United States
(12) Patent Application Publication
(10) Pub. No.: US 2023/0145252 A1
(43) Pub. Date: May 11, 2023

(54) PORTABLE TIRE SCANNERS AND RELATED METHODS AND SYSTEMS

(71) Applicant: Oswego Innovations Two Inc., Lake Oswego, OR (US)

(72) Inventors: Peter J. Barram, Lake Oswego, OR (US); Wayne Allen, Lake Oswego, OR (US); Sanjay Gidwani, Lake Oswego, OR (US)

(73) Assignee: Oswego Innovations Two Inc., Lake Oswego, OR (US)

(21) Appl. No.: 17/794,533

(22) PCT Filed: Jan. 22, 2021
(86) PCT No.: PCT/US21/14658

§ 371 Date: Jul. 21, 2022

Related U.S. Application Data
(60) Provisional application No. 62/965,580, filed on Jan. 24, 2020.

(51) Int. Cl. G06V 30/14; B29D 30/00; G06V 30/142; G06T 5/00; G06V 30/18; G06V 30/146; H04N 23/56

(52) U.S. Cl. CPC G06V 30/1434; B29D 30/0061; G06V 30/142; G06V 30/1437; G06T 5/003; G06V 30/1448; G06V 30/1801; G06T 5/007; G06V 30/147; H04N 23/56; B29D 2030/0066; G06T 2207/20192

(57) ABSTRACT

Disclosed herein are devices and methods for determining the identity of markings on tires. A portable tire scanner can comprise one or more light sources and detector that reflect light off tire markings and capture imagery of them. The scanner is operable to process the imagery to determine the identity of the markings. The marking can be the same color as the area of the tire around the marking (e.g., black-on-black) and the scanner can identify the marking by determining angular edges of the markings. Plural light sources and/or detectors can be used to provide plural perspectives to better determine the edges of the markings. The housing can have a form factor that allows the scanner to be hand-held, such that a user can aim the scanner at tires even while on a vehicle or in hard to reach positions. The scanner can be used to scan and identify several tire marking in succession.

### CROSS-REFERENCE TO RELATED APPLICATIONS

This application claims the benefit of U.S. Provisional Patent Application No. 62/965,580, filed Jan. 24, 2020, which is herein incorporated by reference in its entirety.

### FIELD

The technology disclosed herein relates to devices, systems, and methods for reading and capturing an image from a target object, such as tire surfaces and sidewalls.

### BACKGROUND

Tires for vehicles have raised, depressed, imprinted, and/or other markings on them, such as on the sidewalls, to identify certain information on them, such as the manufacturer's identification mark, the tire size, the year of manufacture, the week of manufacture, the manufacturer's information, and/or other information such as the tire type code. Since in many jurisdictions, the department of transportation or similar authority requires such marking to be imprinted on the tires and the installer of tires or a manufacture of vehicles has a need to keep a record of such imprinting, it can be important to have a means to inspect and record the target objects imprinting in a convenient and easy to use manner

Whereas an installer of tires, as well as the manufacturer of the vehicle, installs a plurality of tires, and on a plurality of vehicles, it can be important to read and capture the vehicle identification number (VIN) of the specific vehicle that has the specific tires.

Whereas an installer of tires, and in some cases the manufacturer of the vehicle, may elect to use different tire manufacturers, or different tire sizes, or simply different tire types based on the installation location, it can be important to read and capture the aforementioned information and also keep a record of which tire is installed in which location of the vehicle.

### SUMMARY

Disclosed herein are devices and methods for determining the identity of markings on tires. A portable hand-held tire scanner can comprise at least one light source and at least one light detector or camera that are operable to reflect light off a tire marking and capture imagery of the reflected light. Based on the captured imagery, the scanner is operable to process the imagery to determine the identity of the marking. The marking can be the same color as the area of the tire around the marking (e.g., black-on-black) and the scanner can identify the marking by determining raised edges of the marking. Plural light sources and/or plural light detectors can be used to provide plural perspectives to better detect the locations of the edges of the markings. The housing can have a form factor that allows the scanner to be hand-held and portable, such that a user can aim the scanner at tires even while on a vehicle or in hard to reach positions. Marking data can be stored and/or transmitted to other devices, and the scanner can be used to scan and identify several tire marking in succession.

Exemplary scanners can comprise a housing, a power supply, at least one processor, at least one light source, at least one light detector, a user interface, a trigger, a region of interest light source, wired and wireless communication connections, and/or other components. The scanner can be operable to read alphanumeric markings, or other markings, on a tire by emitting light from the at least one light source toward the marking and by receiving light reflected from the marking with the at least one light detector, and by processing data associated with the received light with the processor to determine an identity of the marking. The scanner housing can have a form factor that allows the scanner to be hand-held and portable (with or without wired connections). The scanner can process and save scan data internally and/or can transmit the data to other devices or remote locations for processing and storage. In some embodiments, a trigger is included that allows the user to initiate the scanning process or perform other actions.

The tire marking can be raised or depressed relative to an area of the tire around the marking. The relative height differences or changes in angles of the marking relative to the area of the tire around the marking can be detected and utilized to help identify the marking. For example, the marking and the area of the tire around the marking can be a same color (e.g., black-on-black) so that color contrast is of limited use. In one example, the scanner determines the identity of the marking based on a height difference between the marking and the area of the tire around the marking. In one example, the scanner determines edges of the marking that are at angles relative to the area of the tire around the marking.

In some embodiments, the at least one light source comprises plural light sources and/or the at least on light detector comprises plural light detectors. A light detector can be positioned between two of the plural light sources in some embodiments. Similarly, a light source can be positioned between two of the plural light detectors in some embodiments. The light sources and light detectors can be arranged in an alternating pattern in some embodiments. The light sources and light detectors can be arranged in a two-dimensional or three-dimensional pattern in some embodiments.

In some embodiments, the scanner further comprises a region of interest (ROI) light source that illuminates a region of interest on the tire that contains the marking, such that the ROI light source helps a user aim the scanner.

In some embodiments, the processor is configured to apply an edge enhancement algorithm to the data associated with the received light to determine edges of the marking, and in some embodiments, the processor is configured to apply a contrast enhancement algorithm to the data associated with the received light to determine the identity of the marking. In some embodiments, the processor is configured to apply dynamic analysis of the data associated with the received light to determine the identity of the marking.

An exemplary method can comprise receiving data associated with optical imagery of a marking on a tire, determining edges of the marking based on the received data, and then determining an identity of the marking based on the determined edges of the marking. In some methods, the optical imagery of the marking comprises imagery captured from plural different perspectives relative to the marking. In some embodiments, determining the edges of the marking comprises applying an edge enhancement algorithm to the received data. In some embodiments, prior to receiving the data associated with optical imagery of a marking, the method can include causing a ROI light source to illuminate an area of interest on the tire, receiving an indication that the marking is positioned within the area of illuminated area of interest, causing at least one target light source to emit light at the area of interest, and causing at least one light detector to obtain the optical imagery of the marking based on the emitted light reflecting off the area of interest toward the at least one light detector. The method can further comprise storing data associated with the determined identity of the marking, or transmitting data associated with the determined identity of the marking to another device.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 illustrates a general architecture of an exemplary scanner and charging station.

FIG. 2 illustrates an exemplary general scanner architecture.

FIG. 3 is a flow chart for exemplary switches or trigger and indicator interactions.

FIG. 4 is a flow chart for exemplary default and user elected sequenced activation.

FIG. 5 illustrates an exemplary scanner scanning an alphanumeric marking.

### DETAILED DESCRIPTION

In some embodiments, the disclosed technology can provide a novel and improved devices and method for inspecting and analyzing the imprinted markings from the surface and sidewalls of a tire. Embodiments of the disclosed technology relate scanners for scanning tires for all types of vehicles, including automobiles, busses, trucks, motorcycles, electric vehicles, bicycles, off-road vehicles, aircraft vehicles, etc.

One aspect of the disclosed technology is a hand-held portable device for obtaining the imprinted markings from the surfaces and sidewalls of a tire, wherein the device can comprise any one or more of the following:
a) A hand-held image capture device such as a camera or detector, or a plurality of cameras or detectors, to read and capture the visual image of the target object
b) One or a plurality of light source devices to illuminate the target object from different perspective angles
c) One or a plurality of light source devices to mark the region of capture to the user such as a rectangular or circular border, to outline the region.
d) One or a plurality of switches or triggers that can be engaged by a user
e) One or a plurality of indicators that can convey the state of the device
f) A processor device that can process the captured image into text
g) A communication circuit to transmit information from the device to some receiving device
h) Wherein the communication circuit may have a wired connectivity to transmit the information
i) Wherein the communication circuit may have a wireless connectivity to transmit the information
j) Wherein the wireless communication may be a standards based far field transmission type, such as Wi-Fi
k) Wherein the wireless communication may be a standards based near field transmission type such as Bluetooth
l) A rechargeable or replaceable battery to power the hand-held device
m) A recharging circuitry to recharge and protect the battery

The disclosed technology can also include the structures and software for analyzing the tire markings from the surfaces and sidewalls of a tire, which can comprise any one or more of the following:
a) A means and method for capturing a visual image of the target object
b) A means and method for storing a visual image of the target object
c) A means and method for detecting that one or a plurality of switches or triggers was engaged
d) A means and method of conveying the state of the device or system using an indicator
e) A means and method of illuminating a light source to illuminate the target object form different perspective angles
f) A means and method of analyzing the image of the target object to convert the optical image into its representative alphanumeric characters
g) A means and method of analyzing the converted alphanumeric characters to classify the constituent data into constituent fields
h) A means and method to analyze the fields into patterns of formatted information to classify the information into recordable forms such as vehicle identification number, Department of Transportation DOT codes, tire manufacturer, tire size, tire type, tire manufacture year, and tire manufacture week
i) A means and method of dynamic analysis wherein a plurality of enhancement methods is used based on a priori bases to improve the reliability of the classification of the information.

The devices, systems, and methods described herein can be used to record and capture the aforementioned information from a tire into a record of information associating the specific tires with specific vehicles and with specific installation or inspection dates.

In some embodiments, one or a plurality of light sources may be configured to use different spectral region of illumination. Whereas specific features and markings may be enhanced using one specific light source spectrum, other specific features and marking may be enhanced using another specific light source spectrum. In one such example, the enhancement may be by using a light emitting diode (LED) in the green spectrum of the visible light spectrum. In another such example, the enhancement may be by using a LED in the infra-red spectrum. The disclosed technology can include the means and methods of combining the plurality of such images so that the converted alphanumeric characters can be classified with greater reliability due to the greater detectability of the markings by selective use of a plurality of light source spectrums.

The camera or detector within the device can be arranged in such a manner such that the light source may illuminate the target object from differing angles. In one embodiment, using two distinct light sources, the detector may be arranged in the center and each of the two light sources be equidistant from the detector on opposing sides. In such an embodiment, the camera or detector within the device can capture a plurality of images, such as with both light sources illuminated, with one light source illuminated, or with the other light source illuminated. A plurality of images can be used by themselves, or in a combination with enhancements to one or a plurality of images, so that the analysis of the image can be improved. In one such example, the enhancement may be by using an edge enhancement algorithm on one or a plurality of the images, so that the converted alphanumeric characters can be classified with a greater reliability due to the greater enhancements on the edges of the markings. In another such example, the enhancement may be by using a contrast enhancement algorithm on one or a plurality of the images, so that the converted alphanumeric characters can be classified with greater reliability due to the greater enhancement of the imagery contrast in the proximity of the markings.

In some embodiments, a plurality of cameras or detectors within the device can be arranged in such a manner that the light source may illuminate the target object in either one perspective, or a plurality of light sources may illuminate the target object in a plurality of perspectives. In such an embodiment, using two distinct cameras or detectors, and one single light source, the light source may be arranged in the center and each of the two cameras or detectors may be arranged equidistant from the light source on opposing sides. In such an embodiment, the plurality of camera or detectors can capture a plurality of images. A plurality of images from the plurality of cameras or detectors can be used by themselves, or in a combination with enhancement to one or a plurality of images, so that the analysis of the image can be improved. In one such example, the enhancement may be by using an edge enhancement algorithm on one or a plurality of the images, so that the converted alphanumeric characters can be classified with a greater reliability due to the greater enhancement on the edges of the markings. In another such example, the enhancement may be by using a contrast enhancement algorithm on one or a plurality of the images, so that the converted alphanumeric characters can be classified with greater reliability due to the greater enhancement of the imagery contrast in the proximity of the markings.

In some embodiments, a plurality of cameras or detectors within the device can be arranged in such a manner that a plurality of light sources may illuminate the target object in a plurality of perspectives for each of the plurality of the cameras or detectors. In such an embodiment, using a plurality of cameras or detectors, and a plurality of light sources, the cameras or detectors and the light sources may be arranged in alternating order, such that a plurality of images can be formed for each camera or detector by illuminating the plurality of light sources creating a plurality of perspective for each of the cameras or detectors. In such an embodiment, the plurality of images can be used to provide a greater reliability on a per marking basis, based on a specific camera or detector and perspective.

Some embodiments can include means and methods for dynamic analysis. In such an embodiment, for example, but not limited to, the conversion of a given marking, say the letter “I” may have a higher reliability using a specific perspective, whereas another marking, say the dash, “-”, may have a higher reliability using a different perspective. In such an example, the device can use one perspective to achieve a greater reliability on letters expected to be “I”, and the different perspective for the marking “-”. The means and method of dynamic analysis can be used on one or a plurality of images, so that the converted alphanumeric characters can be classified with greater reliability due to the a priori based expectation. In such an embodiment, all expected markings may have an associated preferred perspective to help improve the reliability of the converted information.

In some embodiments, a light source can be used to project an outline within the field of view to indicate a region of interest. In one such an embodiment, the user or the light source may project a rectangular outline of a region of interest. In another such embodiment, the user or the light source may project a circular outline of a region of interest. The user may either directly by observation, or indirectly by use of the camera or detector, be able to use the above mentioned outline to guide the device to provide an optimized perspective of the target within the field of view of the camera or detector.

In some embodiments, one or a plurality of switches or triggers within the device can be engaged by the user. Some embodiments can also include means and methods of keeping the sequence, frequency, and/or timing of one or a plurality of switches, such that specific action will take place based on the sequence, frequency, and/or timing of activating the specific switch or trigger. In one such embodiment, one specific button may be engaged by the user to activate the device and place the device into a start sequence. In another such example, the one specific start button may be engaged by the user to activate the present inventing and place it into a start sequence when engaged a first time, or place the device into a restart sequence when engaged a subsequent time. In some embodiments, for example, one specific button may be engaged by the user to activate the camera or detector within the device and activate the means and method for the device to capture one or a plurality of images. In some embodiments, for example, one specific button may be engaged by the user to activate one or a plurality of light sources within the device. In some embodiments, one switch or trigger may be used to provides a plurality of means and methods, such as activating the device into a start sequence, and further activating the camera or detector, and further activating the one or plurality of light sources, or any combination of the plurality of means and methods described herein.

Some embodiments can be capable of analyzing the captured images of the markings and subdividing the images into smaller images with specific regions of interest. Some embodiment can further include the means and methods to classify the specific regions of interest into fields of interests. The fields of interest can be further subdivided to classify the information into patterns of formatted information into recordable forms such as vehicle identification number, Department of Transportation DOT codes, tire manufacturer, tire size, tire type, tire manufacture year, and tire manufacture week.

In some embodiments, the sequence of the one or a plurality of switches or triggers engaged within the device can have a specific meaning. In such an embodiment, for example, one sequence may be to capture one, or a plurality of images, wherein, the first formatted information recorded is the vehicle identification number. In such an embodiment, the second formatted information recorded can be, for example, the tire surface of the front driver side tire. Furthermore, in such an embodiment, the third formatted information recorded can be, for example, the tire surface of the rear driver side tire. In such an embodiment, the user can have an a priori expectation that subsequent formatted information will capture specific recordable information from specific target locations.

In some embodiments, the aforementioned sequence of captures can be elected and changed by the user.

In some embodiments, the sequence may be limited to a maximum discrete number for recorded information, for example, nine captures. In such an embodiment, for example, the nine captures may be of the vehicle identification number, followed by a maximum of eight sets of captured images of the marking of up to eight tire surfaces, with specific a priori order. The maximum discrete number can be any number desired.

In some embodiments, one or a plurality of indicators that can convey the state of the device can be available for the user's observation. In such an embodiment, the indicators can be configured such that the state of the hand-held device can be simply illustrated by an a priori configuration. In such an embodiment, for example, a red light emitting diode can used to indicate that the device is powered on and in a non-ready state. In such an embodiment, for another example, a green light emitting diode can be used to indicate that the device is powered on and in a ready state to capture information. In some embodiments, one or a plurality of indicators can be used to convey the state of the sequence of captures, for example, to indicate that the device is ready to capture the rear passenger tire information.

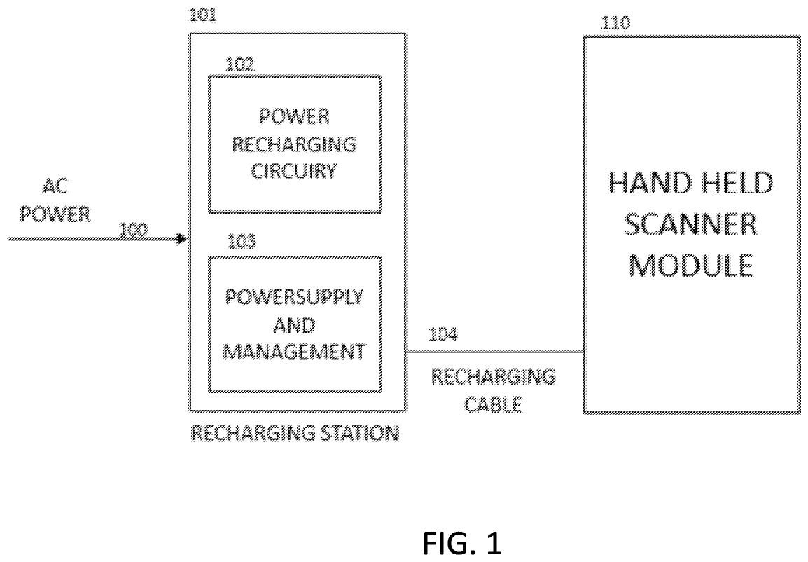

FIG. 1 illustrates an exemplary system comprising a hand-held portable scanner 110 according to the disclosed technology coupled via a recharging cable 104 to a recharging station 101 that includes power charging circuitry 102 and a power supply and management module 103, and is coupled to an AC power supply 100.

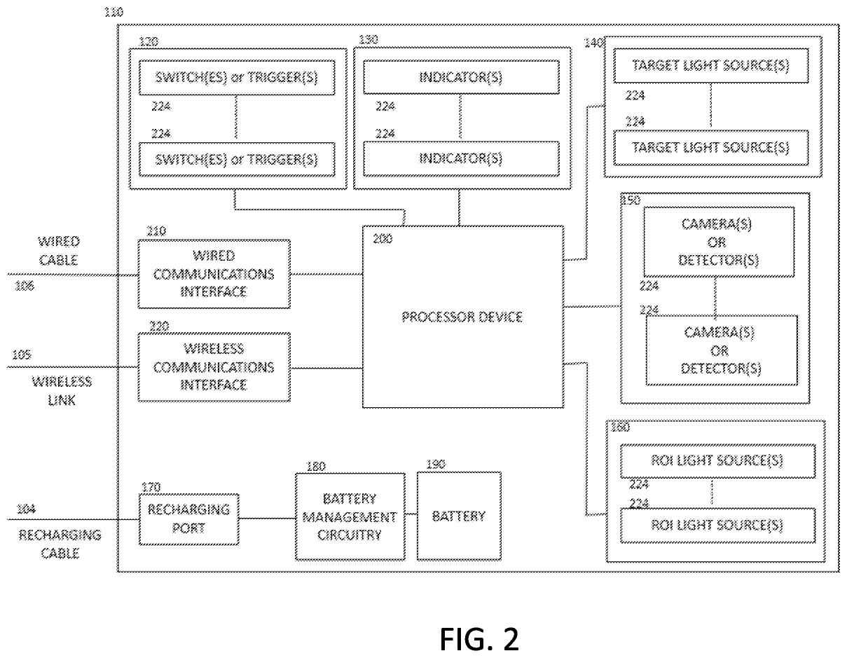

FIG. 2 illustrates the hand-held portable scanner 110 is more detail. The scanner 110 can comprise a battery 190 coupled to a battery management circuit 180 and a recharging portion 170, which is couple to the recharging cable 104. The scanner 110 can also comprise one or more processors, such as processor 200 configured to implement various processes as disclosed herein. The processor 200 can be coupled to a wired communications interface 210 that is coupled to the wired cable 106 and/or can be coupled to a wireless communications interface 220 that communicates via a wireless link 105. The scanner 110 can also comprise a switch/trigger module 120 comprising one or more switches or triggers 224, an indicator module 130 comprising one or more indicators, a target light source module 140 comprising one or more target light sources, a camera/detector module 150 comprising one or more cameras or detectors, and/or a Region of Interest (ROI) light source module 160 comprising one or more ROI light sources, all of which can be operatively coupled to the processor 200. The scanner 110 can also comprise additional features not shown in FIG. 2, including structural features, a housing, other user interface features, other communications features, other storage and processing features, etc.

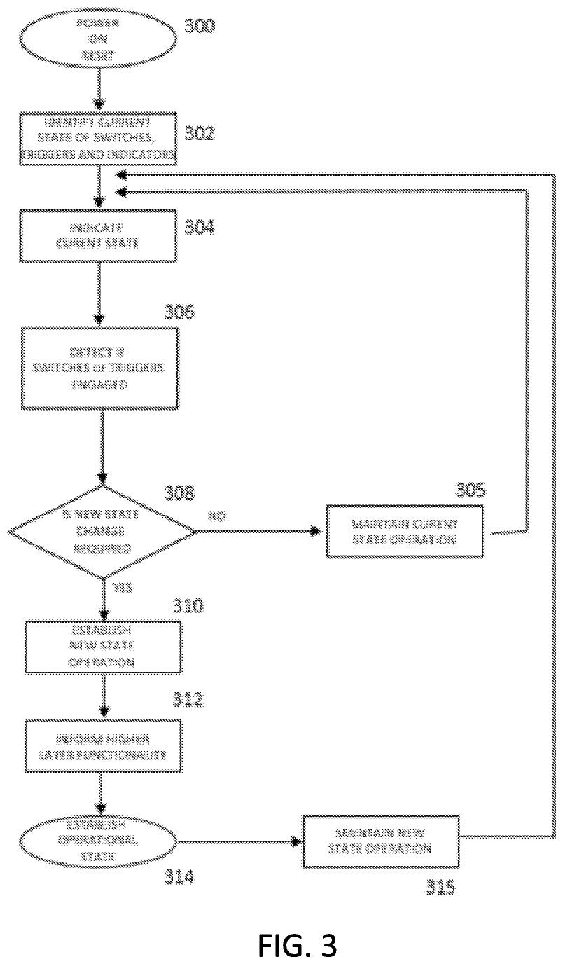

FIG. 3 illustrates an exemplary method that the scanner 110 and/or the processor 200 can perform. Once powered on or reset at 300, the scanner can identify a current state of switches/triggers at 302 and can then indicate the current state at 304 and detect if switches/triggers are engaged at 306. At 308 it is determined if a new state change is required. If no, then the current state operation is maintained at 305 and the process returns to 304. If yes, then a new state operation is established at 310 and higher layer functionality is informed at 312 to establish an operational state at 314. At 315 the new state operation is maintained and the process returns to 304.

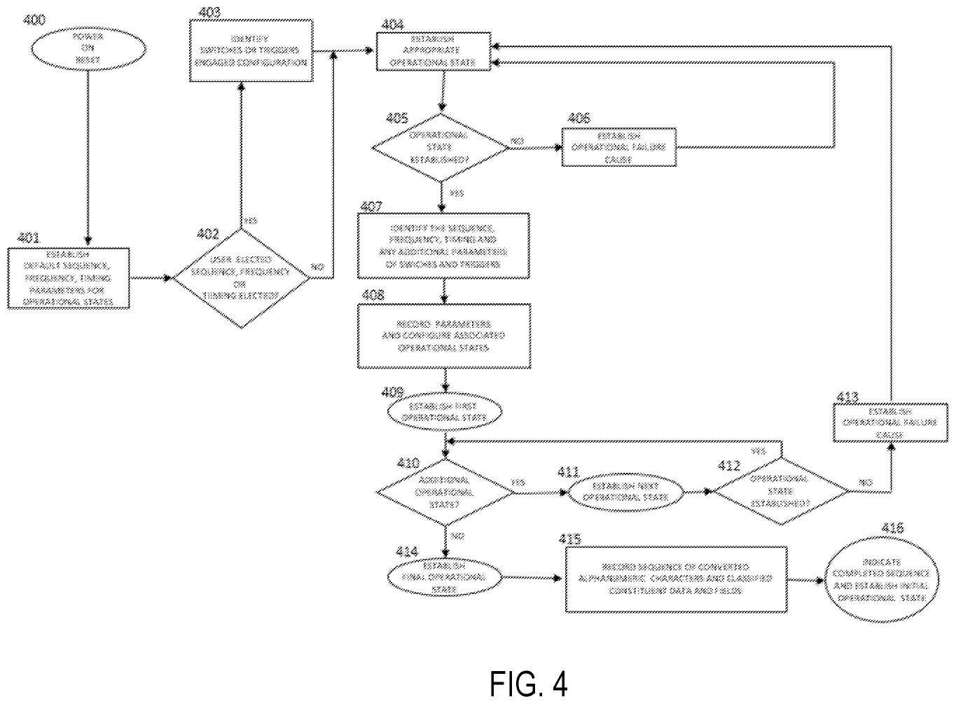

FIG. 4 illustrates another exemplary method that the scanner 110 and/or the processor 200 can perform. Once powered on or reset at 400, the scanner can establish default sequence, frequency, and/or timing parameters for operational states at 401. If a user elected sequence, frequency, and/or timing is elected at 402, then it can identify a switches/triggers engaged configurations at 403. Then, or if no at 402, it can establish an appropriate operation state at 404. Then, at 405, if an operation state is not established, it can establish an operational failure cause at 406 and return to 404. If yes at 405, it can then identify the sequence, frequency, timing, and/or any additional parameters of switches/triggers at 407, record parameters and configure associated operational states at 408, and establish a first operation state at 409. Then, at 410, if there is to be an additional operational state, it can establish the next operation state at 411, and if established at 412, return to 410. If the operational state is not established at 412, it can establish an operational failure cause at 413 and then return to 404. If there is no additional operational state at 410, then it can establish a final operational state at 414, record a sequence of converted alphanumeric characters and classified constituent data and field at 415, and indicate a completed sequence and establish an initial operational state at 416.

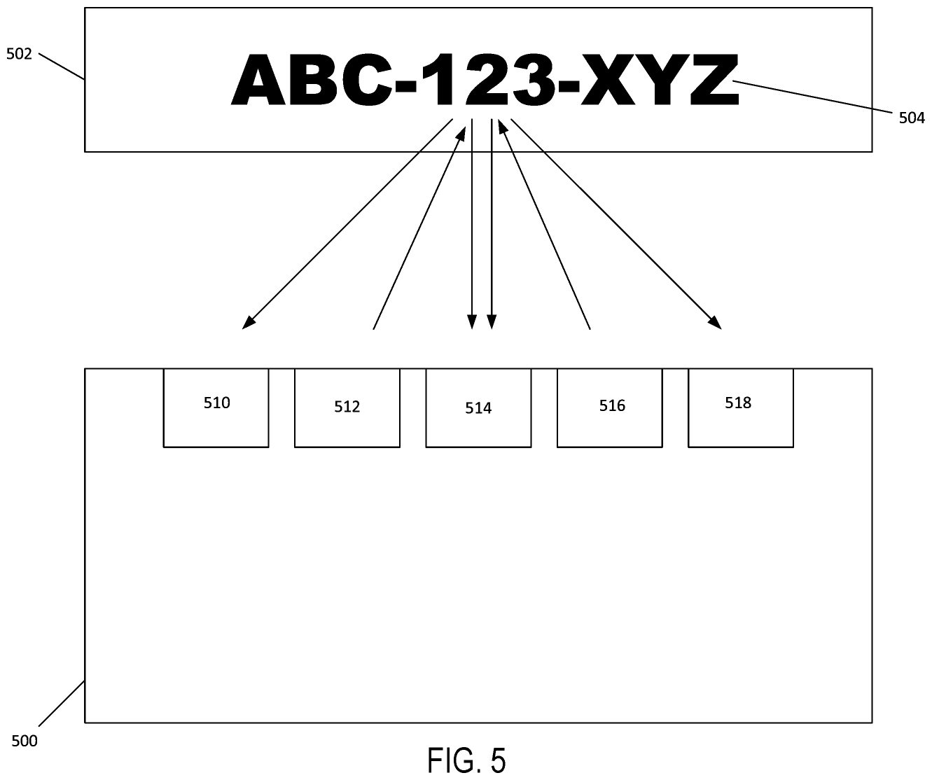

FIG. 5 illustrates an exemplary scanner 500 that can comprise any of the features of the scanner 110 or other scanners described herein. FIG. 5 shows the scanner 500 interacting with a target or ROI 502 (e.g., a portion of a sidewall of a tire, etc.) to read alphanumeric markings 504 located on the target. The marking “ABC-123-XYZ” shown in FIG. 5 is just an example used for illustrative purposes. The scanner 500 can include any number of light sources and light detectors (or cameras), such as 510, 512, 514, 516, and 518 shown in FIG. 5. In one example, 512 and 516 can be light sources, and 510, 514, and 518 can be light detectors. In this example, light is emitted from two different directions from sources 512 and 516, which light can collectively reflect off of the marking 504 and be detected/captured from three different perspectives by detectors 510, 514, and 518. In other embodiments, there can be different numbers of light sources (e.g., one, two, three, four, or more) and/or different numbers of light detectors (e.g., one, two, three, four, or more). FIG. 5 illustrates the light sources and light detectors arranged in a one-dimensional linear pattern. However, in other embodiments, the various light sources and light detectors can be arranged in many different patterns, including in two-dimensional patterns (e.g., three light detectors arranged in a triangular pattern) and three-dimensional patterns. In addition, the scanner 500 and/or the target 502 can be moved relative to each other (translated, rotated, moved closer or farther away, etc.) to scan the marking 504 from different angles and perspectives.

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Characteristics, properties, method steps, applications, and other features described in conjunction with a particular aspect, embodiment, or example of the disclosed technology are to be understood to be applicable to any other aspect, embodiment, or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A”, “B,”, “C”, “A and B”, “A and C”, “B and C”, or “A, B, and C.” As used herein, the term “coupled” means physically, electrically, magnetically, chemically, or otherwise in communication or linked and does not exclude the presence of intermediate elements between the coupled elements absent specific contrary language.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents.

1. A portable tire scanner comprising:
a housing;
a power supply;
a processor;
a plurality of light sources operatively coupled to the processor; and
a plurality of light detectors operatively coupled to the processor;
wherein the plurality of light sources and the plurality of light detectors are arranged in a linear alternating pattern;
wherein the processor is configured to cause the scanner to:
capture one or more images of a region of interest on a tire by causing one or more of the plurality of light sources to project light to the region of interest and causing one or more of the plurality of light detectors to receive light reflected from the region of interest;
apply edge enhancement to the one or more images to determine edges of an alphanumeric marking in the region of interest; and
determine an identity of the alphanumeric marking based on the determined edges.

2. The scanner of claim 1, wherein the housing has a form factor that allows the scanner to be hand-held and portable.

3. The scanner of claim 1, further comprising a trigger, wherein the scanner reads the marking following actuation of the trigger.

4. The scanner of claim 1, wherein the marking is raised or depressed relative to an area of the tire around the marking, the marking and the area of the tire around the marking are a same color, and the scanner determines the identity of the marking based on a height difference between the marking and the area of the tire around the marking.

5. The scanner of claim 4, wherein the scanner determines edges of the marking that are at angles relative to the area of the tire around the marking.

6. (canceled)

7. (canceled)

8. (canceled)

9. (canceled)

10. (canceled)

11. (canceled)

12. (canceled)

13. The scanner of claim 1, further comprising a region of interest (ROI) light source separate from the plurality of light sources, wherein the ROI light source is operatively coupled to the processor and illumination from the ROI light source helps a user aim the scanner at the region of interest.

14. The scanner of claim 1, wherein the processor is configured to apply an edge enhancement algorithm to the data associated with the light received by the one or more of the plurality of light detectors to determine edges of the marking.

15. The scanner of claim 1, wherein the processor is configured to apply a contrast enhancement algorithm to the data associated with the light received by the one or more of the plurality of light detectors to determine the identity of the marking.

16. The scanner of claim 1, wherein the processor is configured to apply dynamic analysis of the data associated with the light received by the one or more of the plurality of light detectors to determine the identity of the marking.

17. A method comprising:
receiving data associated with capturing one or more images of a marking on a tire using a plurality of light sources and a plurality of light detectors arranged in a linear alternating pattern;
determining edges of the marking based on the received data; and
determining an identity of the marking based on the determined edges of the marking.

18. The method of claim 17, wherein the marking and an area of the tire around the marking are a same color, and the marking is raised or depressed relative to the area of the tire around the marking.

19. The method of claim 18, wherein the one or more images are captured from plural different perspectives relative to the marking.

20. The method of claim 19, wherein determining the edges of the marking comprises applying an edge enhancement algorithm to the received data.

21. (canceled)

22. The method of claim 17, further comprising storing data associated with the determined identity of the marking, or transmitting data associated with the determined identity of the marking to another device.

23. A method comprising:
illuminating a region of interest on a tire using one or more first light sources;
capturing one or more images of the illuminated region of interest using one or more second light sources and one or more detectors; and
determining an identity of a marking within the region of interest from the one or more images.

24. The method of claim 23, further comprising receiving an indication that the marking is positioned within the illuminated region of interest prior to capturing the one or more images of the illuminated region of interest.

25. The method of claim 23, further comprising determining edges of the marking in the region of interest from the one or more images;
wherein determining the identity of the marking within the region of interest from the one or more images comprises determining the identity of the marking based on the determined edges of the marking.

26. The method of claim 23, wherein capturing the one or more images comprises causing the one or more second light sources to emit light that is directed to the region of interest and causing the one or more detectors to detect light reflected from the region of interest.
